(19) United States
(12) Patent Application Publication
(10) Pub. No.: US 2011/0217532 A1
(43) Pub. Date: Sep. 8, 2011

(54) OPTICAL COMPONENT AND MANUFACTURING METHOD THEREOF

(75) Inventors: Takeshi Deguchi, Tokyo (JP); Yoshito Ito, Tokyo (JP); Kei Kikuchi, Tokyo (JP); Nobuyoshi Toyohara, Sagamihara-shi (JP)

(73) Assignee: Olympus Corporation, Tokyo (JP)

(21) Appl. No.: 13/038,684

(22) Filed: Mar. 2, 2011

(30) Foreign Application Priority Data
Mar. 8, 2010 (JP) 2010-050671

(51) Int. Cl. B32B 7/02; H05H 1/24; B05D 5/06; B32B 33/00; G02B 1/10

(52) U.S. Cl. 428/217; 427/569; 427/162; 428/212; 428/409

(57) ABSTRACT

An optical component includes a multilayered optical thin film formed on a substrate. A critical load value of the optical thin film that includes at least one layer that is formed by a vacuum deposition method is greater than or equal to 30 mN. The critical load value is a value evaluated by a measurement method complying with JIS R3255 “Testing methods for adhesion of thin films on a glass substrate”.

### CROSS-REFERENCE TO RELATED APPLICATIONS

The present application is based upon and claims the benefit of priority from the prior Japanese Patent Application No. 2010-50671 filed on Mar. 8, 2010; the entire contents of which are incorporated herein by reference.

### BACKGROUND OF THE INVENTION

1. Field of the Invention

The present invention relates to an optical component and a manufacturing method thereof.

2. Description of the Related Art

Substrates made of resin have come to be used more commonly in recent years to manufacture optical systems inexpensively and in large quantities. A substrate made of resin is less hard as compared to a substrate made of glass. Furthermore, an optical thin film such as an antireflective film formed on the resin substrate or a low-pass filter gets easily scratched. Therefore, it is necessary to improve a scratch resistance and a hardness of the optical thin film.

An optical member is proposed in Japanese Patent Application Laid-open No. 2009-199022 with a view to providing a solution to the above-described problem. The optical member is provided with a thin film of a low refractive index layer made of a film coating material made of SiO₂ and Al₂O₃, that has an improved film density and excellent scratch resistance, without a hard coat layer that is normally used in a spectacle lens. To improve the film density, an ion assisted deposition method is used for forming the low refractive index layer.

### SUMMARY OF THE INVENTION

An optical component according to an aspect of the present invention includes a multilayered optical thin film formed on a substrate. A critical load value of the optical thin film that includes at least one layer that is formed by a vacuum deposition method is greater than or equal to 30 mN. The critical load value is a value evaluated by a measurement method complying with JIS R3255 “Testing methods for adhesion of thin films on a glass substrate”.

A method of manufacturing an optical component according to another aspect of the present invention includes forming an optical thin film on a substrate. A critical load value of the optical thin film that includes at least one layer that is formed by a vacuum deposition method, is greater than or equal to 30 mN. The critical load value being a value evaluated by a measurement method complying with JIS R3255 “Testing methods for adhesion of thin films on a glass substrate”.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a graph depicting a relation between an applied power (in units of watts (W)) and a critical load value (in units of millinewtons (mN)) that are control parameters of a plasma assisted deposition method during SiO₂ film deposition; and

FIG. 2 is a graph depicting a relation between an applied power (in units of W) and a Young's modulus (in units of gigapascals (GPa)) that are control parameters of the plasma assisted deposition method during SiO₂ film deposition.

### DETAILED DESCRIPTION OF THE PREFERRED EMBODIMENTS

Exemplary embodiments of an optical component and a manufacturing method thereof according to the present invention are explained below in detail with reference to the accompanying drawings. However, the present invention is not limited to the embodiments described below.

### Example 1

The optical component according to the present invention includes a multilayered optical thin film on a substrate. An antireflective film is explained as an example of the optical thin film. In the antireflective film formed of multiple layers, at least one layer is formed by a vacuum deposition method and a critical load value of this layer of the antireflective film is greater than or equal to 30 mN.

The value of the critical load is evaluated by a measurement method complying with JIS R3255 “Test methods for adhesion of thin films on a glass substrate”.

A structure of the antireflective film of the optical component according to Example 1 is given in Table 2. The antireflective film is formed of alternating Ta₂O₅ and SiO₂ layers arranged in that order from a substrate side.

The antireflective film that serves as the optical thin film of multiple layers of a low refractive index material SiO₂ and a high refractive index material Ta₂O₅ is formed on a surface of a resin substrate. The antireflective film has a four-layer structure with alternating Ta₂O₅ and SiO₂ layers, the first layer on the substrate side being that of Ta₂O₅. The substrate is made of resin of polycarbonate series. A plasma gun is used to perform plasma irradiation during the deposition of the Ta₂O₅ and SiO₂ layers of the antireflective film using a plasma assisted deposition method.

The low refractive index material SiO₂ used in the present Example can be of any shape. It can be granular, sintered pellets, or molten ring. A mixture with Al₂O₃ can also be used as long as the main component is SiO₂.

TiO₂ or Nb₂O₅ can be used in place of Ta₂O₅ as a high refractive index material. Similar to the low refractive index material, the high refractive index material also can be of any shape.

The substrate has a dimension of 30 millimeter (mm)×30 mm×1.5 mm. The dimension of the substrate is the same in all the Examples described below.

In the antireflective film according to Example 1, a plasma gun is used to perform plasma irradiation during the deposition of at least one layer of the optical thin film of multiple layers using the plasma assisted deposition method.

The ion assisted deposition method can be used in place of the plasma assisted deposition method. In the ion assisted deposition method or the plasma assisted deposition method, parameters (for example, gas flow amount, irradiation time, and applied power) should preferably be controlled according to a constituent material of the layer being formed.

### (Conditions for Scratch Test)

A method for measuring the critical load value is explained below. The critical load value is a value that corresponds to a scratch resistance of the optical thin film. Conditions when measuring the critical load value are shown in Table 1.

TABLE 1
Settings of parameters used during evaluation in trial runs

| | | |
|---|---|---|
| Tester | Micro scratch tester | |
| | (CSR-2000) | |
| Stylus | Shape of diamond tip | 15 μm |
| | Spring constant | 100 g/mm |
| Scratching speed | 10 μm/sec | |
| Excitation frequency | 45 Hz | |
| Excitation width | 100 nm | |
| Load application speed | 450 mN/180 sec | |

A diamond stylus is provided at a tip of a cantilever. Because an equivalent mass of the stylus is extremely small, minute variations on a surface of the thin film can be identified with a high sensitivity while scanning the thin film using the stylus. Vibrations of the stylus tip pass through the cantilever, and are converted into an electric signal inside a cartridge.

Direct current signals cannot be output from the cartridge carrying such a converted form of the vibrations. Therefore, the cartridge is forcibly horizontally excited to generate alternating current signals. Micro-vibrations of the stylus can be converted into an electric signal having a good sensitivity. A testing range is of the order of 1 mN to 1 Newton (N).

A diameter of the stylus tip can be selected from a range of 5 micrometers (μm) to 100 μm. Thus, there is a significant freedom in applying pressure on the surface of the thin film. An optimum diameter can be selected as the stylus diameter of a diamond indenter based on a measurement sample.

### (Conditions for Hardness Test)

A method for measuring a Young's modulus is explained below. The Young's modulus is a value that corresponds to a hardness of the optical thin film. An indentation testing is performed for measuring the hardness. In the indentation testing, the load applied on the antireflective film and displacement of the antireflective film when the load is applied are measured. Specifically, application of the load and displacement due to application of load are measured with a high precision.

Particularly, according to a CSM method, that is, a so-called continuous stiffness measurement method, the hardness and an elastic modulus at each indentation depth can be continuously measured in a single push-in test.

A measurement procedure is explained below. A minute amount of AC signal is added to a load DC signal and a force is caused to micro-vibrate during indentation. Furthermore, a load amplitude and a displacement response amplitude/phase are measured according to a time, and a rigidity (stiffness) at each depth is measured continuously. A Berkovich diamond indenter that has a triangular pyramidal shape is used as the indenter. The indentation depth is targeted at approximately 30% of the film thickness.

TABLE 2

| | First | Second | Third | Fourth | Fifth | Sixth | Seventh |
|---|---|---|---|---|---|---|---|
| | layer | layer | layer | layer | layer | layer | layer |
| Example 1 | Ta₂O₅ | SiO₂ | Ta₂O₅ | SiO₂ | | | |
| Example 2 | SiO₂ | TiO₂ | SiO₂ | TiO₂ | SiO₂ | | |
| Example 3 | SiO₂ | TiO₂ | SiO₂ | TiO₂ | SiO₂ | TiO₂ | MgF₂ |
| Example 4 | SiO | SiO₂ | TiO₂ | SiO₂ | TiO₂ | SiO₂ | |

### Example 2

As shown in Table 2, an antireflective film is formed of alternating SiO₂ and TiO₂ layers arranged in that order from the substrate side.

The plasma assisted deposition method is used only for forming the SiO₂ layer of the antireflective film.

The antireflective film that serves as an optical thin film of multiple layers of a low refractive index material SiO₂ and a high refractive index material TiO₂ is deposited on the surface of the resin substrate. The antireflective film has a five-layer structure with alternating SiO₂ and TiO₂ layers, the first layer on the substrate side being that of SiO₂. A plasma gun is used to perform plasma irradiation during the deposition of the SiO₂ layer of the antireflective film using the plasma assisted deposition method.

The substrate is made of resin of cycloolefin series.

### Example 3

As shown in Table 2, an antireflective film has a seven-layer structure, and is formed of alternating SiO₂ and TiO₂ layers arranged in that order from the substrate side up to the sixth layer. The seventh layer is an MgF₂ layer. The plasma assisted deposition method is used only for forming the SiO₂ layer and the MgF₂ layer of the antireflective film. The substrate is made of a resin of polycarbonate series.

### Example 4

As shown in Table 2, an antireflective film has a structure similar to that of Example 2. The antireflective film has a six-layer structure, the first layer being that of SiO that serves as an adhesive layer. A plasma gun is used to perform plasma irradiation during the deposition of the SiO₂ layer of the antireflective film using the plasma assisted deposition method. The substrate is made of a resin of acrylic series.

### Comparative Example 1

An antireflective film of Comparative Example 1 has a four-layer structure that is similar to that of Example 1, and is formed using only a vapor deposition method.

### Comparative Example 2

An antireflective film of Comparative Example 2 has a five-layer structure that is similar to that of Example 2, and is formed using only the vapor deposition method.

### Comparative Example 3

An antireflective film of Comparative Example 3 has a seven-layer structure that is similar to that of Example 3, and is formed using only the vapor deposition method.

### Comparative Example 4

An antireflective film of Comparative Example 4 has a six-layer structure that is similar to that of Example 4, and is formed using only the vapor deposition method.

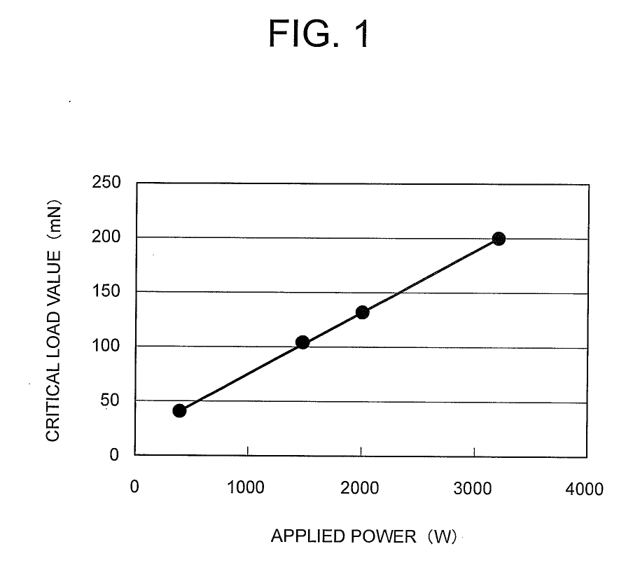

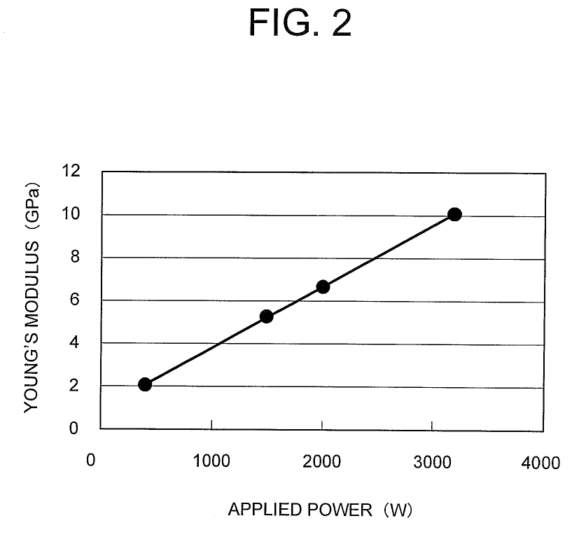

FIG. 1 is a graph depicting a relation between an applied power (in units of W) and a critical load value (in units of mN) that are control parameters of the plasma assisted deposition method during SiO₂ film deposition. FIG. 2 is a graph depicting a relation between an applied power (in units of W) and the Young's modulus (in units of GPa) that are control parameters of the plasma assisted deposition method during SiO₂ film deposition. As can be seen from FIGS. 1 and 2, the power applied to the plasma gun and the critical load, and the power applied to the plasma gun and the Young's modulus are proportional. That is, a thin film of a desired critical load value and the Young's modulus can be formed by controlling the predetermined parameters in the plasma assisted deposition method.

Values of the critical load and the Young's modulus are shown in Table 3 for each Example and Comparative Example.

TABLE 3

| | Critical load | Young's modulus |
|---|---|---|
| Name | value (mN) | (GPa) |
| Resin of cycloolefin | 50 | 0.23 |
| series | | |
| Resin of polycarbonate | 40 | 0.20 |
| series | | |
| Resin of acrylic series | 110 | 0.26 |
| Example 1 | 40 | 4.0 |
| Example 2 | 55 | 3.5 |
| Example 3 | 50 | 3.5 |
| Example 4 | 110 | 3.3 |
| Comparative Example 1 | 32 | 2.0 |
| Comparative Example 2 | 32 | 2.0 |
| Comparative Example 3 | 27 | 2.0 |
| Comparative Example 4 | 35 | 2.0 |

In Examples 1 to 4, the critical load value of the antireflective film is greater by 70% or above relative to a critical load value of the substrate.

Furthermore, the Young's modulus of the antireflective film is greater than or equal to ten times a Young's modulus of the substrate.

The optical thin film described above should preferably be the outermost layer of the multilayered film.

The gas used in the plasma assisted deposition method used for forming the optical thin film can be of any type. It is desirable to form the optical thin film using the plasma assisted deposition method in which a mixture of oxygen gas and argon gas is used.

According to the present invention, an optical thin film is obtained that has an improved scratch resistance (critical load value) and a hardness (Young's modulus). As a result, a lightweight optical system can be formed inexpensively.

As described above, the optical thin film according to the present invention can make the optical system inexpensive and lightweight.

According to the present invention, a critical load value, that is, a scratch resistance of an optical thin film formed on a substrate can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical component including a multilayered optical thin film formed on a substrate,
wherein a critical load value of the optical thin film that includes at least one layer that is formed by a vacuum deposition method is greater than or equal to 30 mN, and
the critical load value being a value evaluated by a measurement method complying with JIS R3255 “Test methods for adhesion of thin films on a glass substrate”.

2. The optical component according to claim 1, wherein a Young's modulus, measured by a nano-indentation measuring method, of the optical thin film that includes at least one layer that is formed by the vacuum deposition method, is greater than or equal to 3 GPa.

3. The optical component according to claim 1, wherein the critical load value of the optical thin film is greater by 70% or above relative to a critical load value of the substrate.

4. The optical component according to claim 3, wherein a Young's modulus of the optical thin film is greater than or equal to ten times a Young's modulus of the substrate.

5. The optical component according to claim 1, wherein the optical thin film that includes at least one layer that is formed by the vacuum deposition method, is formed by a plasma assisted deposition method.

6. The optical component according to claim 1, wherein the optical thin film is an outermost layer of the multilayered film.

7. The optical component according to claim 1, wherein the substrate is made of resin.

8. A method of manufacturing an optical component comprising:
forming an optical thin film on a substrate,
wherein a critical load value of the optical thin film that includes at least one layer that is formed by a vacuum deposition method is greater than or equal to 30 mN, and
the critical load value being a value evaluated by a measurement method complying with JIS R3255 “Testing methods for adhesion of thin films on a glass substrate”.

9. The method of manufacturing the optical component according to claim 8, wherein a Young's modulus, measured by a nano-indentation measuring method, of the optical thin film that includes at least one layer that is formed by the vacuum deposition method, is greater than or equal to 3 GPa.

10. The method of manufacturing the optical component according to claim 8, wherein the critical load value of the optical thin film is greater by 70% or above relative to a critical load value of the substrate.

11. The method of manufacturing the optical component according to claim 10, wherein a hardness of the optical thin film is greater than or equal to ten times a hardness of the substrate.

12. The method of manufacturing the optical component according to claim 8, wherein the optical thin film that includes at least one layer that is formed by the vacuum deposition method, is formed by a plasma assisted deposition method.

13. The method of manufacturing the optical component according to claim 8, wherein the optical thin film is an outermost layer of the multilayered film.

14. The method of manufacturing the optical component according to claim 8, wherein the substrate is made of resin.
